(19) United States
(12) Patent Application Publication
(10) Pub. No.: US 2025/0261138 A1
(43) Pub. Date: Aug. 14, 2025

(54) MULTI-MODE SYNCHRONIZATION SIGNALING FOR A SECONDARY CELL

(71) Applicant: Qualcomm Incorporated, San Diego, CA (US)

(72) Inventors: Jianghong LUO, Skillman, NJ (US); Navid ABEDINI, Basking Ridge, NJ (US); Naeem AKL, Bridgewater, NJ (US); Changhwan PARK, San Diego, CA (US)

(21) Appl. No.: 18/440,421

(22) Filed: Feb. 13, 2024

(51) Int. Cl. H04W 56/00

(52) U.S. Cl. CPC H04W 56/001

(57) ABSTRACT

Certain aspects of the present disclosure provide techniques for multi-mode synchronization signaling of a secondary cell. An example method for wireless communications by an apparatus includes obtaining, via a first cell, a first configuration for communications via a second cell; obtaining an indication to switch from a first mode to a second mode for synchronization signal communications via the second cell, wherein the first mode is different than the second mode; obtaining, via the second cell, at least one synchronization signal in accordance with the second mode; and communicating one or more signals via the second cell based at least in part on the at least one synchronization signal.

### INTRODUCTION

### Field of the Disclosure

Aspects of the present disclosure relate to wireless communications, and more particularly, to techniques for multi-mode synchronization signaling for a secondary cell.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining, via a first cell, a first configuration for communications via a second cell; obtaining an indication to switch from a first mode to a second mode for synchronization signal communications via the second cell, wherein the first mode is different than the second mode; obtaining, via the second cell, at least one synchronization signal in accordance with the second mode; and communicating one or more signals via the second cell based at least in part on the at least one synchronization signal.

Another aspect provides a method for wireless communications by an apparatus. The method includes sending, via a first cell, a first configuration for communications via a second cell; sending an indication to switch from a first mode to a second mode for synchronization signal communications via the second cell, wherein the first mode is different than the second mode; sending, via the second cell, at least one synchronization signal in accordance with the second mode; and communicating with a user equipment via the second cell based at least in part on the at least one synchronization signal.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example wireless communications system where multi-mode synchronization signaling is applied to one or more secondary cells (SCells).

FIG. 6 depicts an example architecture for an energy saving mode and an active mode associated with multi-mode synchronization signaling.

FIG. 7 depicts an example scheme for indicating one or more synchronization signals associated with an SCell in energy saving mode.

FIG. 8 depicts a process flow for SCell synchronization signaling mode switching.

FIG. 9 depicts another process flow for SCell synchronization signaling mode switching.

FIG. 10 depicts an example scheme of communicating multi-mode synchronization signaling with multiple UEs.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for multi-mode synchronization signaling for a secondary cell.

In certain wireless communications systems (e.g., 5G New Radio (NR) systems and/or any future wireless communications system), a user equipment (UE) may communicate with one or more network entities (e.g., a base station) through multiple cells, for example, using carrier aggregation and/or dual connectivity. Communications through multiple cells may enable increased data rates and/or reduced latencies. As an example, a UE may communicate through a primary cell (PCell), which may serve as an anchor for configuring other cell(s), and one or more secondary cells (SCells). As further described herein, a cell may correspond to a geographic coverage area of wireless communications and/or carrier frequency associated with one or more network entities.

Technical problems for multi-cell communications (e.g., carrier-aggregation and/or dual connectivity) include, for example, providing effective energy savings and channel usage for synchronization signaling of an SCell. In some cases, the energy savings for the SCell may be implemented through an SCell that refrains from transmitting certain synchronization signaling (e.g., periodic synchronization signal blocks (SSBs)), and in such cases, the PCell provides the synchronization signaling for communications on the SCell (such as time-frequency synchronization, path loss estimation, etc.). Such an SCell that does not transmit SSBs may be referred to as an SSB-less SCell. An SSB-less SCell may be reserved for certain carrier aggregation scenarios due to the synchronization signaling for the SCell being provided via the PCell. Such carrier aggregation scenarios may include intra-band carrier aggregation and inter-band carrier aggregation in the same frequency range (e.g., Frequency Range 1 (FR1) as further described herein). Intra-band carrier aggregation may involve the PCell and SCell being arranged in the same frequency band, whereas intra-band carrier aggregation may involve the PCell and SCell being arranged in different frequency bands.

In certain cases, energy savings for the SCell may be provided through an on-demand SSB. In an on-demand SSB scheme, a network entity may send an SSB through the SCell in response to a request for transmission of the SSB from a UE. However, an on-demand SSB scheme for SCell may be reserved for UEs that are in a connected-mode with the network entity. For example, a UE with a radio resource control (RRC) connection may be allowed to request an on-demand SSB from an SCell. In addition, an on-demand SSB scheme may affect the latency of time-frequency synchronization and/or other operations (e.g., beam management and/or radio link failure detection) associated with the SCell.

Aspects described herein overcome the aforementioned technical problem(s) by providing multi-mode synchronization signaling of a SCell. In certain aspects, the multi-mode synchronization signaling may include one or more energy saving modes and an active mode, and the network entity may switch between an energy saving mode and the active mode depending on a level of traffic between the network entity and a UE. As an example, the network entity may use an energy saving mode for the SCell synchronization signaling when the UE is in an idle mode, when the SCell is deactivated for communications at the UE, and/or when there are no UEs in the coverage area in the SCell. The network entity may use the active mode for the SCell synchronization signaling when the UE is in a connected mode and/or when the SCell is activated for communications at the UE.

During an energy saving mode, certain energy saving settings may be activated for the synchronization signaling on the SCell. The energy saving settings for the synchronization signaling may include, for example, an increased periodicity, a shorter burst pattern duration, fewer component signals (e.g., one or more synchronization signals without a broadcast channel or certain system information), etc. In some cases, during an energy saving mode, the network entity may refrain from sending synchronization signaling via the SCell. During the active mode, the SCell may be activated for communications at a UE, and synchronization signaling is communicated via the SCell with different settings than the energy saving modes. For example, during the active mode, the network entity may send synchronization signaling via the SCell with a shorter periodicity and/or with more information (e.g., a broadcast channel and/or certain system information) than during any of the energy saving modes.

The techniques for SCell multi-mode synchronization signaling described herein may provide various beneficial technical effects and/or advantages. The techniques for SCell multi-mode synchronization signaling may enable improved wireless communication performance, such as enhanced channel usage and/or energy savings at a network entity and/or a UE. The improved wireless communication performance may be attributable to the energy saving modes that allow communication of synchronization signaling with a greater periodicity, shorter burst pattern duration, fewer component signals, etc. Accordingly, a network entity and/or UE may expend less energy and fewer channel resources communicating the SCell synchronization signaling during the energy saving mode. In some cases, the SCell multi-mode synchronization signaling may enable energy savings and/or enhanced channel usage through temporarily refraining from sending synchronization signaling via the SCell during an energy saving mode. The SCell multi-mode synchronization signaling may enable the enhanced channel usage and/or energy savings through dynamic switching between the active mode and the energy saving mode depending on, for example, the traffic level between the network entity and the UE.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

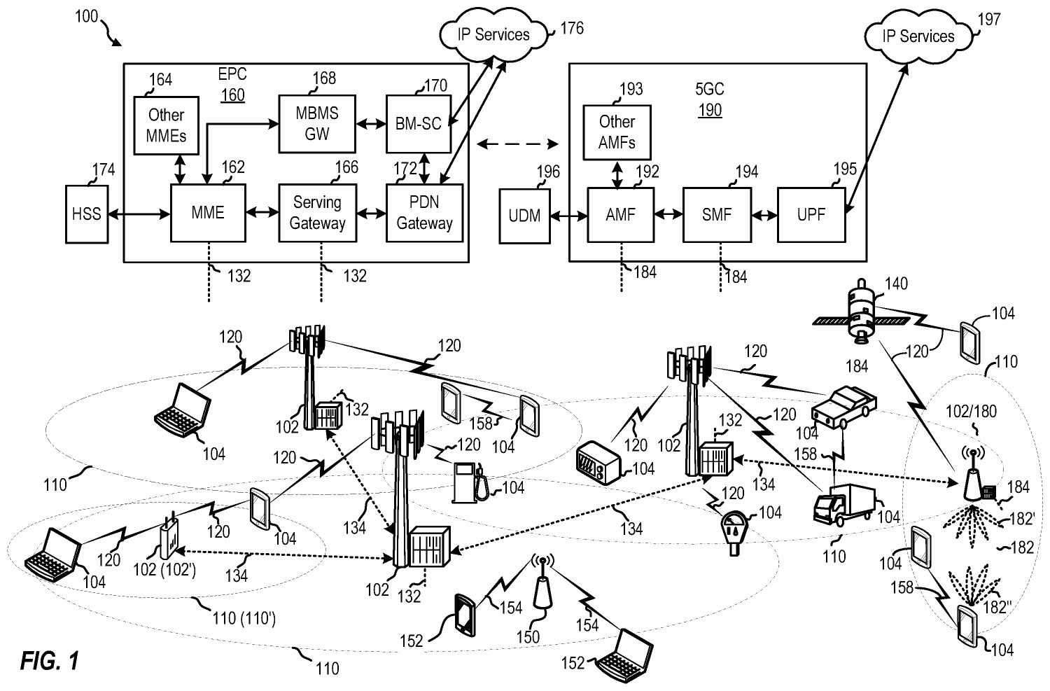

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

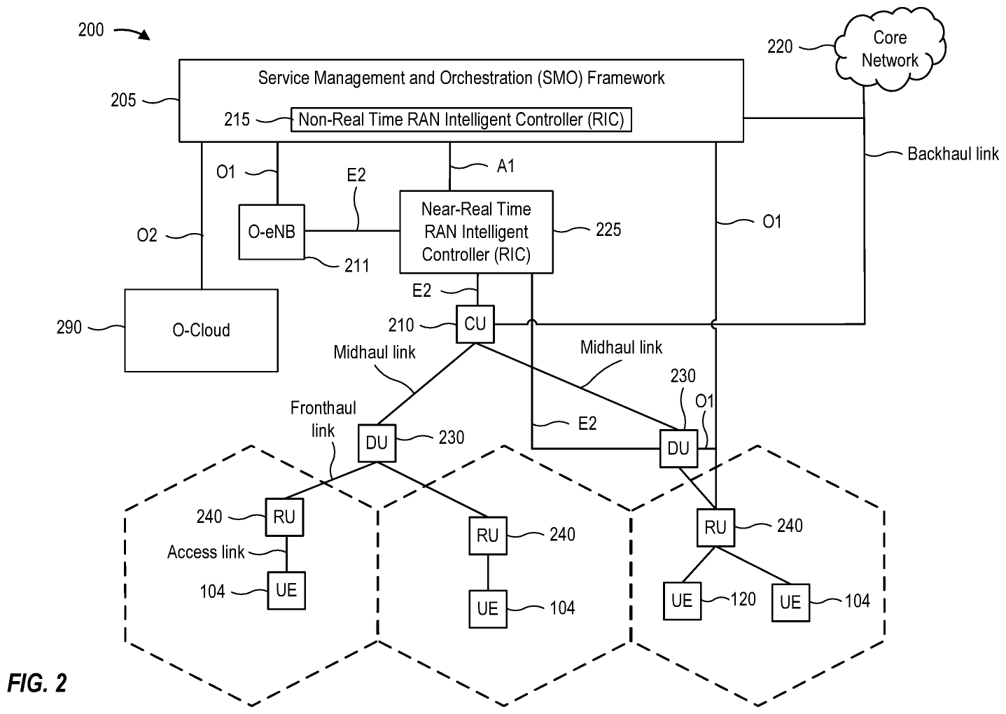

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

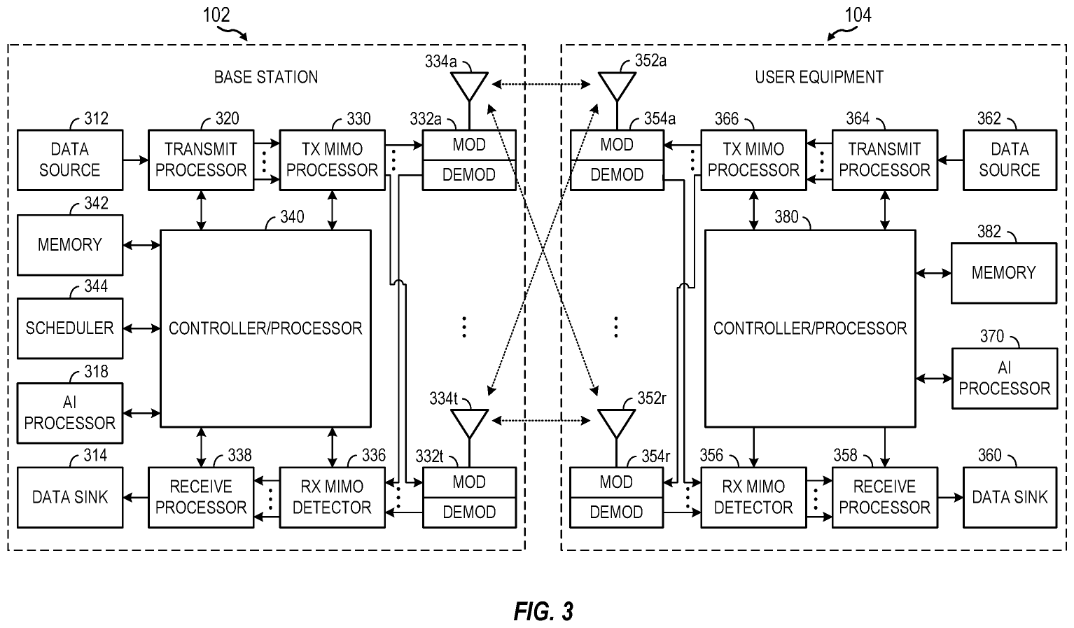

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

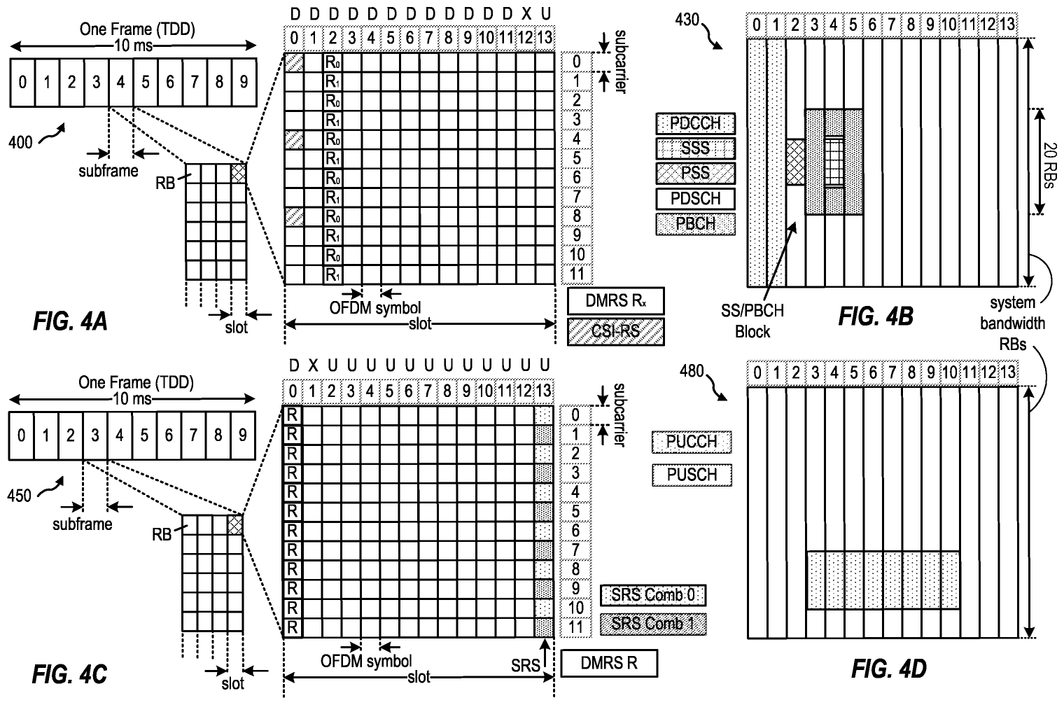

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to SCell Multi-Mode Synchronization Signaling

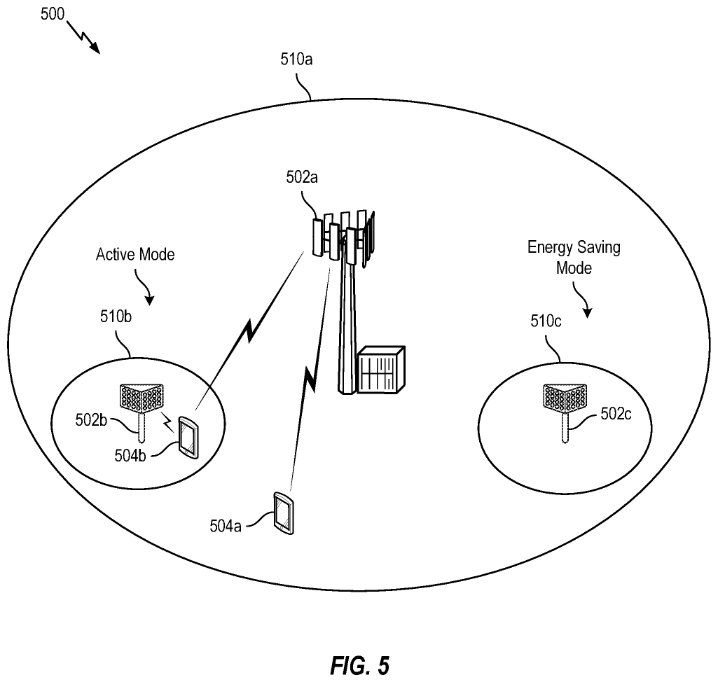

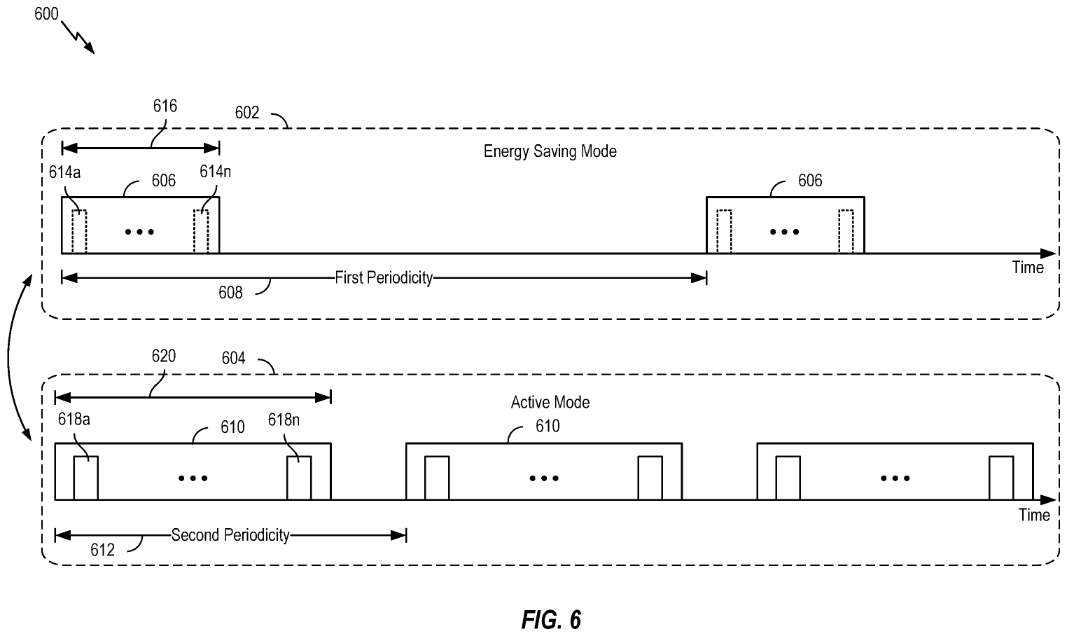

Aspects of the present disclosure provide multi-mode synchronization signaling of an SCell. The multi-mode synchronization signaling may include an energy saving mode and an active mode, as further described herein with respect to FIGS. 5 and 6. As an example, the energy saving mode may correspond to a synchronization signaling configuration that defines less synchronization signaling activity (few signals, shorter durations, smaller channel occupancy, etc.) than an active mode. The multi-mode synchronization signaling may enable dynamic switching between multiple modes depending on the traffic of a UE, for example, depending on if an SCell is activated or deactivated for communications with a UE.

FIG. 5 illustrates an example wireless communications system 500 wherein multi-mode synchronization signaling is applied to one or more SCells. In this example, the wireless communications system 500 includes a first network entity 502a with a wireless communications coverage area corresponding to a first cell 510a, a second network entity 502b with a wireless communications coverage area corresponding to a second cell 510b, and a third network entity 502c with a wireless communication coverage area corresponding to a third cell 510c. As shown, the first network entity 502a may not be co-located with the second network entity 502b and third network entity 502c. Thus, the second cell 510b and third cell 510c may not be configured as SSB-less cells due to certain characteristics and/or specifications associated with SSB-less cells as discussed above. Note that the locations of the network entities 502a-c depicted in FIG. 5 are examples to facilitate understanding of the multi-mode synchronization signaling. Aspects of the present disclosure may equally be applied to cells and/or network entities that are co-located with each other.

In the depicted example, a first UE 504a is in communication with the first network entity 502a via the first cell 510a, which may correspond to a carrier frequency. A second UE 504b is in communication with the first network entity 502a via the first cell 510a and the second network entity 502b via the second cell 510b. For the second UE 504b, the first cell 510a may serve as an anchor cell or primary serving cell, and the second cell 510b may be an SCell. For example, the second UE 504b may obtain, via the first cell 510a, a configuration for communicating via the second cell 510b. In certain aspects, the second UE 504b may have the first cell 510a and the second cell 510b configured in a cell group. In some cases, the multi-carrier communications with the second UE 504b via the cell group may be referred to as carrier aggregation.

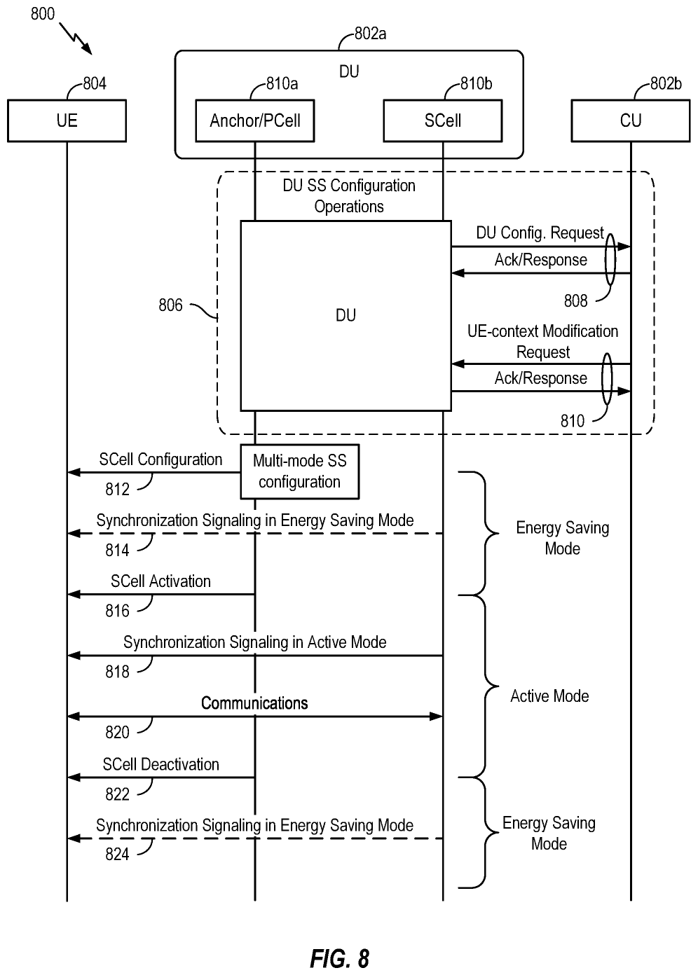

The UEs 504a, 504b may be configured with multi-mode synchronization signaling settings associated with the second cell 510b and/or the third cell 510c. As an example, the second UE 504b may be configured with multiple modes of synchronization signaling for the second cell 510b during configuration of the second cell 510b as an SCell, for example, as further described herein with respect to FIG. 8. The second UE 504b may switch among the multiple modes of synchronization signaling in response to whether the second cell 510b is activated or deactivated as an SCell. For example, when the second cell 510b is activated as an SCell, the second UE 504b may monitor for synchronization signaling via the second cell 510b according to the active mode settings. When the second cell 510b is deactivated as the SCell, the second UE 504b may monitor for synchronization signaling via the second cell 510b according to the energy saving mode settings.

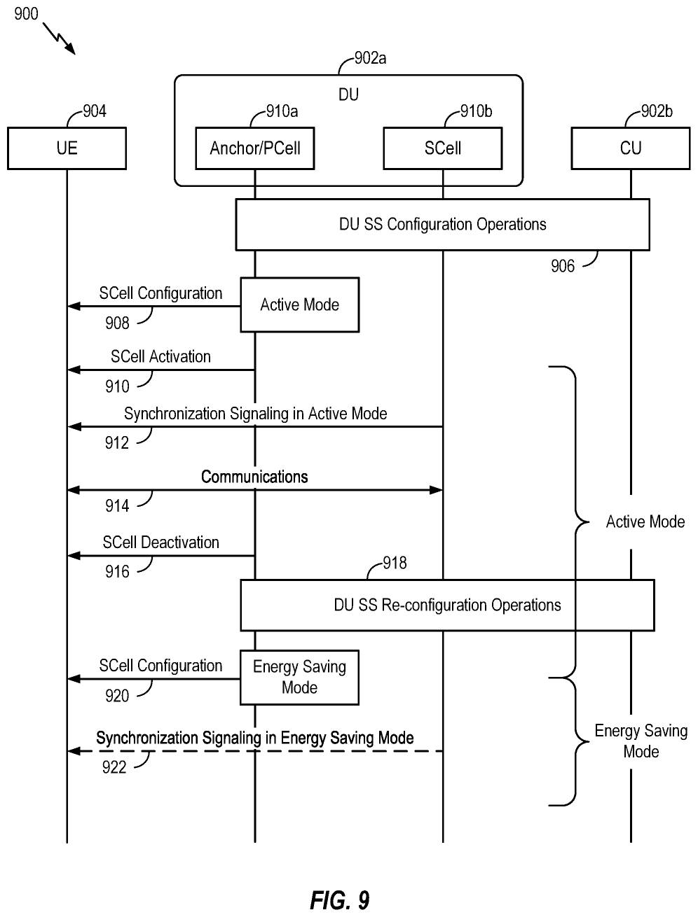

In certain aspects, the second UE 504b may be configured with a single mode of synchronization signaling for the second cell 510b, for example, as described herein with respect to FIG. 9. Thus, in order to switch between modes (e.g., an energy saving mode and an active mode), the second UE 504b may obtain a re-configuration for the synchronization signaling settings of the next mode for the second cell 510b, for example, via a modification of the settings associated with the second cell 510b as an SCell.

As an example, the second network entity 502b may be communicating synchronization signaling via the second cell 510b in an active mode, as further described herein with respect to FIG. 6, and the second UE 504b may monitor for the synchronization signaling via the second cell 510b according to the active mode settings. As there are no UEs in the third cell 510c, the third network entity 502c may be communicating synchronization signaling (or refraining from communicating such signaling) via the third cell 510c in an energy saving mode, as further described herein with respect to FIG. 6.

Suppose, for example, the first UE 504a moves into the coverage area of the third cell 510c. In response to traffic being communicated via the first UE 504a, the first network entity 502a may notify the first UE 504a that the synchronization signaling mode of the third cell 510c is switching to an active mode. Accordingly, the first UE 504a may monitor for synchronization signaling via the third cell 510c with respect to the active mode settings.

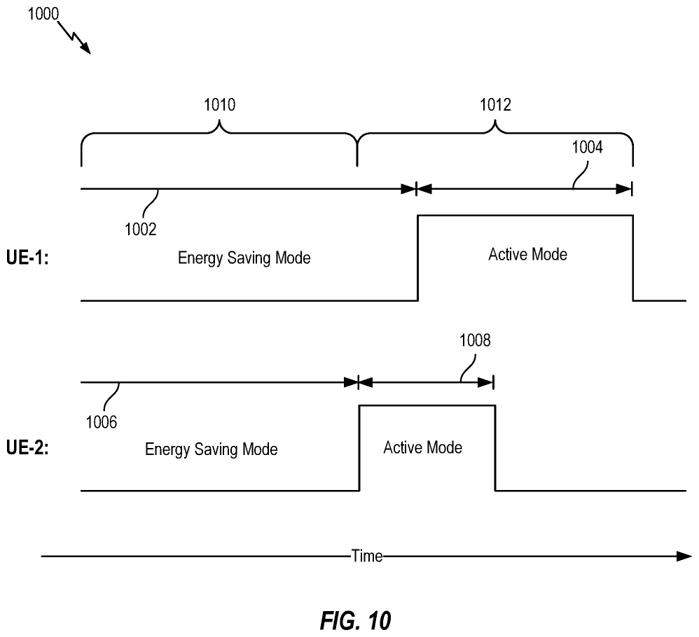

As another example, suppose the first UE 504a moves into the coverage area of the second cell 510b and enters into an idle mode, the first network entity 502a may then notify the first UE 504a that the synchronization signaling mode of the second cell 510b is in an energy saving mode to facilitate power savings at the first UE 504a and/or the second network entity 502b. In certain aspects, the multi-mode synchronization signaling settings configured among the UEs 504a, 504b may be specific to each of the UEs 504a, 504b. The energy saving modes and active modes may occur at different times for the UEs 504a, 504b. In some cases, the energy saving modes configured for the UEs may overlap in time. The second network entity 502b may communicate the synchronization signaling via the second cell 510b in a first energy saving mode for the first UE 504a and a second energy saving mode for the second UE 504b. In some cases, the second network entity 502b may communicate the synchronization signaling via the second cell 510b in an energy saving mode for the first UE 504a and an active mode for the second UE 504b. Thus, the multi-mode synchronization signaling described herein may be adapted to UE-specific communications, as further described herein with respect to FIG. 10.

### Example Modes for SCell Multi-Mode Synchronization Signaling

FIG. 6 illustrates an example architecture 600 for an energy saving mode 602 and an active mode 604 associated with multi-mode synchronization signaling. In this example, each of the energy saving mode 602 and the active mode 604 may be defined based on one or more parameters for the synchronization signaling, as further described herein.

In the energy saving mode 602, the synchronization signaling may be communicated via a first set of one or more synchronization signals 606 (hereinafter “the first SS set 606”) with a first periodicity 608, whereas in the active mode 604, the synchronization signaling may be communicated via a second set of one or more synchronization signals 610 (hereinafter “the second SS set 610”) with a second periodicity 612. Note that in some cases, the energy saving mode 602 may be configured such that a network entity refrains from communicating synchronization signaling, and/or a UE refrains from monitoring for synchronization signaling. For example, the network entity may refrain from sending any SSB transmissions during the energy saving mode, and/or the UE may refrain from monitoring for any SSB transmissions during the energy saving mode.

The first SS set 606 may be representative of a synchronization signal (SS) burst or an SSB burst, which may include a sequence of SSBs 614a-n arranged in a first time period 616 (e.g., a sequence of one or more slots having a duration less than a half frame). The time domain positions of the SSBs 614a-n in the first SS set 606 may be referred to as an SSB burst pattern. Generally speaking, the first SS set 606 may be representative of the second SS set 610, except that the first SS set 606 may have certain settings or parameters that are different from the second SS set 610. For example, the second SS set 610 may be a sequence of SSBs 618a-n arranged in a second time period 620 (e.g., a half frame). In certain aspects, the first time period 616 (or duration) of the first SS set 606 may be less than the second time period 620 of the second SS set 610. The shorter duration of the first time period 616 may allow for shorter or no time gaps between the SSBs 614a-n associated with the energy saving mode 602. In certain aspects, the first SS set 606 may have a total number of SSBs that is less than the corresponding total number of SSBs associated with the second SS set 610. For example, the first SS set 606 may have fewer SSBs 614a-n with wider beam widths than the SSBs 618a-n in the second SS set 610.

In certain cases, the first SS set 606 may be a sub-selection of SSBs based on channel state information (CSI) reported by a UE (e.g., the first UE 504a and/or second UE 504b of FIG. 5). A network entity may obtain CSI associated with SSBs from UE(s), and the network entity may determine a subset of SSBs that can be used in the first SS set 606 based on the CSI. As an example, the CSI may indicate that certain SSBs provide stronger signal quality and/or strengths than other SSBs depending on where a UE is located in a cell, and the network entity may use the subset of SSBs for the first SS set 606.

Each of the SSBs 614a-n associated with the energy saving mode 602 may include certain component signals including one or more synchronization signals, such as the PSS and/or SSS as described herein with respect to FIG. 4B. In certain aspects, each of the SSBs 614a-n associated with the energy saving mode 602 may occupy fewer symbols than the SSBs 618a-n associated with the active mode 604. For example, an SSB 614a associated with the energy saving mode 602 may occupy one to two symbols, whereas an SSB 618a associated with the active mode may occupy four symbols. In certain aspects, the SSBs 614a-n associated with the energy saving mode 602 may include fewer component signals than the SSBs 618a-n associated with the active mode. As an example, an SSB 614a associated with the energy saving mode may include one or more synchronization signals (e.g., PSS, SSS, and/or a tertiary synchronization single (TSS)) without certain system information, such as the PBCH and/or the RMSI.

In certain aspects, the one or more parameters that define a specific synchronization signaling mode (e.g., an active mode or an energy saving mode) may include a periodicity, component signal(s) of an SSB, a burst pattern, a duration of a burst pattern, and/or a total number of SSBs in an SSB burst. The synchronization signaling mode parameter(s) may be specified in a wireless communications standard (e.g., 5G NR or any other future standard) and/or signaled to a UE via a network entity.

In certain aspects, the first SS set 606 may have one or more other characteristics that are different from the second SS set 610. The first SS set 606 may be arranged in different time and/or frequency resources than the second SS set 610. As an example, the first SS set 606 may have different center frequencies and/or frequency offsets than the second SS set 610.

In certain aspects, the first SS set 606 and/or the second SS set 610 may be configured to allow a UE to perform channel state measurements, beam management (e.g., beam failure detection), radio link monitoring (e.g., radio link failure detection), and/or mobility measurements. In certain aspects, the first SS set 606 may be configured to allow a UE to perform a subset of operations compared to the second SS set 610, such as radio resource management measurements including mobility measurements.

In certain aspects, a UE and/or network entity may be configured to switch between the energy saving mode 602 and the active mode 604 in response to certain event(s), criteria, and/or a timing sequence. In some cases, the UE may be configured to switch between the energy saving mode 602 and the active mode 604 in response to certain signaling that indicates to switch to a different mode. The UE may be configured to apply the current mode until signaled to switch to a different mode.

In certain cases, the active mode 604 may be applied to the synchronization signaling of an SCell (e.g., the second cell 510b) while the SCell is activated for communications at a UE (e.g., the second UE 504b), and the energy saving mode 602 may be applied to the synchronization signaling of the SCell while the SCell is deactivated at the UE. In some cases, the active mode 604 may be applied to the synchronization signaling of an SCell while the SCell is activated with an active bandwidth part (BWP) in an active state (e.g., the BWP is not in a dormancy state) at the UE, and otherwise, the energy saving mode may applied to the synchronization signaling of the SCell.

In certain cases, a UE and/or network entity may be configured to switch between the energy saving mode 602 and the active mode 604 based on a sequence that defines a duration for the energy saving mode 602 and/or active mode 604. For example, the active mode 604 may be applied to the synchronization signaling of an SCell for a first duration of time, and then after the active mode 604, the energy saving mode 602 may be applied to the synchronization signaling of the SCell for a second duration of time. The UE may be configured with a start time, an end time, and/or a duration for any of the modes.

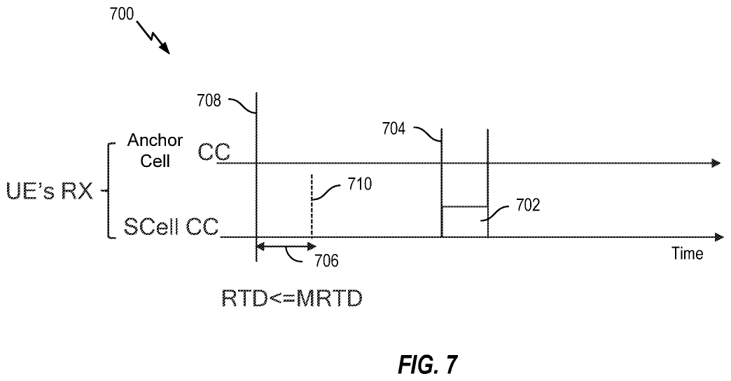

FIG. 7 illustrates an example scheme 700 for indicating one or more synchronization signals associated with an SCell in energy saving mode. In this example, an SSB 702 (e.g., the SSB 614a of FIG. 6) associated with an energy saving mode may be communicated, in a component carrier (CC) via an SCell (e.g., the second cell 510b of FIG. 5), without certain system information, such as the PBCH and/or the RMSI. Such system information may indicate or carry the corresponding SSB index, the half frame timing, and/or the system frame number (SFN) associated with the SSB transmission via the SCell.

If a UE reports CSI associated with the SSB 702 (or communicates any other information that identifies an SCell SSB), the UE may identify the SSB 702 in the CSI based on a slot timing associated with an anchor cell (e.g., the first cell 510a of FIG. 5). For example, the SSB 702 obtained via the SCell (e.g., the second cell 510b of FIG. 5) may be identified in terms of a known slot timing 704 of the anchor cell. The slot timing 704 may be indicated in terms of the system frame number associated with the anchor cell. The slot timing 704 may indicate a particular frame, slot, or symbol index associated with the anchor cell. A network entity may use the CSI associated SSBs of an SCell to select a subset of SSBs for transmission in the energy saving mode and/or active mode to save power or trigger aperiodic reference signal(s) (e.g., a tracking reference signal (TRS) and/or CSI-RS).

There may be a receive timing difference (RTD) 706 between slot timing 708, 710 of signaling from the anchor cell and SCell, respectively, for example, due to the anchor cell and the SCell not being co-located with each other. The RTD 706 may be less than a maximum RTD (MRTD) specified for a wireless communications system, such as 5G NR systems and/or any suitable future wireless communications system. As an example, the MRTD may be set to 33 microseconds (us) for inter-FR1 bands, 25 us for inter-FR1-FR2 bands, and/or 8 us for inter-FR2 bands.

Note that the energy saving modes described herein are provided as example modes to facilitate an understanding of certain aspects of the present disclosure. Other modes may be used in addition to or instead of the energy saving modes. The energy saving modes may enable various beneficial effects or advantages in addition to or instead of energy savings or reduced power consumption, such as reduced channel usage.

### Examples of SCell Synchronization Signaling Mode Switching

In certain aspects, a UE may be configured with multiple SCell synchronization signaling modes of configurations. The multi-mode synchronization signaling configuration may enable efficient selection among the multiple synchronization modes. In some cases, the UE may be configured to switch to a specific synchronization signaling mode depending on whether the SCell is active or not. For example, the signaling for SCell activation or deactivation may be or trigger a synchronization signaling mode switch. Thus, the multi-mode synchronization signaling configuration may enable selection of a particular mode without additional control signaling being communicated.

FIG. 8 depicts a process flow 800 for SCell synchronization signaling mode switching in a system including a first network entity 802a, a second network entity 802b, and a UE 804. The first network entity 802a may communicate with the UE 804 via a first cell 810a (e.g., the first cell 510a) and/or a second cell 810b (e.g., the second cell 510b). In certain aspects, the first network entity 802a and/or second network entity 802b may be an example of the BS 102 depicted and described with respect to FIGS. 1 and 3 or a disaggregated base station depicted and described with respect to FIG. 2. In some aspects, the first network entity 802a may be an example of the DU 230 of FIG. 2, and the second network entity may be an example of the CU 210 of FIG. 2. Similarly, the UE 804 may be an example of UE 104 depicted and described with respect to FIGS. 1 and 3. However, in other aspects, UE 804 may be another type of wireless communications device, and network entities 802a, 802b may be another type of network entity or network node, such as those described herein. Note that any operations or signaling illustrated with dashed lines indicate that that operation or signaling may be an optional or alternative example.

At 806, the first network entity 802a communicates with the second network entity 802b to perform certain network entity (e.g., DU) synchronization signaling (SS) configuration operations. As an example, at 808, the first network entity 802a sends, to the second network entity 802b a DU configuration request. The DU configuration request may include an indication of the configurations for the different synchronization signaling modes, such as the energy saving mode 602 and the active mode 604 of FIG. 6. For example, the DU configuration request may include a first configuration for an energy saving mode and a second configuration for an active mode. In certain aspects, the DU configuration request may be or include a setup request for a CU-DU interface (e.g., an F1-setup request message) and/or a gNB-DU configuration update message as specified in the F1 application protocol for signaling between a DU and CU. The communications interface that connects a CU to a DU may be referred to as an F1 interface. The second network entity 802b sends an acknowledgement (ACK) associated with and/or a response to the DU configuration request. As an example, the ACK and/or response may indicate that the second network entity 820b acknowledges that the requested synchronization signaling modes are successfully obtained at the second network entity 820b. The ACK and/or response may include modifications and/or additions to the requested the requested synchronization signaling modes.

At 810, the second network entity 802b sends, to the first network entity 802a, a UE-context modification request that indicates the second cell 810b to be added or modified for communications with the UE 804. In certain aspects, the UE-context modification request may include a UE-specific configuration for multi-mode synchronization signaling.

At 812, the UE 804 obtains, from the first network entity 802a via the first cell 810a, a configuration for multi-mode synchronization signal communications. In certain aspects, the configuration may be or include a configuration for SCell communications via the second cell 810b (e.g., an SCell configuration of a cell group configuration). The SCell configuration may be or include a serving cell configuration (e.g., servingcellConfigComm) that includes or indicates certain values or settings for the one or more parameters associated with each of the modes: SSB burst periodicity (ssb-periodicityServingCell), SBB burst pattern (ssb-PositionsInBurst), SSB transmit power (ss-PBCH-BlockPower), and/or a frequency location of the SSB (absoluteFrequencySSB). In certain aspects, the configuration may be indicated via a separate configuration from the SCell configuration. As an example, the configuration may add or modify the second cell 810b as an SCell for communications. The configuration may indicate a first set of parameters for synchronization signal communications in an energy saving mode and a second set of parameters for synchronization signal communications in an active mode, for example, as described herein with respect to FIG. 6. In certain aspects, the configuration may be obtained via radio resource control (RRC) signaling and/or system information.

In certain aspects, the configuration may indicate when to apply the energy saving mode and/or the active mode for synchronization signal communications via the second cell 810b. As an example, the configuration may indicate that the energy saving mode is applied when the second cell 810b is deactivated at the UE 804, and that the active mode is applied when the second cell 810b is activated at the UE 804. Note that separate signaling from the SCell activation or deactivation signaling may be communicated to trigger a switch from the energy saving mode to the active mode, or vice versa. The signaling that indicates to switch to a different synchronization signaling mode may be communicated via RRC signaling, medium access control (MAC) signaling (e.g., a MAC control element (MAC-CE)), downlink control information (DCI), and/or system information.

At 814, the UE 804 obtains, from the first network entity 802a via the second cell 810b, synchronization signaling (e.g., at least one synchronization signal) in accordance with the energy saving mode. As an example, the first network entity 802a communicates synchronization signaling in the energy saving mode as described herein with respect to FIG. 6, and the UE 804 may monitor for synchronization signaling from the first network entity 802a via the second cell 810b in transmission occasions that are allocated for the energy saving mode (e.g., the transmission occasions associated with the first SS set 606 of FIG. 6). In certain cases, the UE 804 may refrain from monitoring for synchronization signaling while the energy saving mode is applied or active. As discussed herein, the energy saving mode may reduce power consumption and/or channel usage at the UE 804 and/or the first network entity 802a.

At 816, the UE 804 obtains, from the first network entity 802a via the first cell 810a, an indication that the second cell 810b is activated for communications as an SCell between the UE 804 and the first network entity 802a. The activation indication may also indicate that the active mode is applied for synchronization signaling via the second cell 810b, and thus, the activation indication may provide efficient signaling to trigger the active mode. More specifically, the activation indication may indicate to switch from the energy saving mode to the active mode for synchronization signaling via the second cell 810b. Note that other signaling (e.g., via MAC signaling and/or DCI) may be used to indicate the switch from the energy saving mode to the active mode, or vice versa.

At 818, the UE 804 obtains, from the first network entity 802a via the second cell 810b, synchronization signaling (e.g., at least one synchronization signal) in accordance with the active mode. As an example, the first network entity 802a communicates synchronization signaling in the active mode as described herein with respect to FIG. 6, and the UE 804 may monitor for synchronization signaling from the first network entity 802a via the second cell 810b in transmission occasions that are allocated for the active mode (e.g., the transmission occasions associated with the second SS set 610 of FIG. 6).

At 820, the UE 804 communicates with the first network entity 802a via the second cell 810b, for example, based on the synchronization signaling obtained at 818. The synchronization signaling may indicate or carry timing, frequency, and/or spatial information for one or more communication links between the UE 804 and the first network entity 802a. For example, the synchronization signaling may be used to determine time and/or frequency synchronization parameters (e.g., pre-compensation parameters) for communications via the second cell 810b. The synchronization signaling may indicate quasi colocation information, such as transmit and/or receive beamforming, associated with the second cell 810b.

At 822, the UE 804 obtains, from the first network entity 802a via the first cell 810a, an indication to deactivate the second cell 810b for communications as an SCell.

The deactivation indication may also indicate that the energy saving mode is applied for synchronization signaling via the second cell 810b. More specifically, the deactivation indication may indicate to switch from the active mode to the energy saving mode for synchronization signaling via the second cell 810b, and thus, the deactivation indication may provide efficient signaling to trigger the energy saving mode. Switching to the energy saving mode upon deactivation of the SCell may enable the first network entity 802a and/or UE 804 to reduce energy consumption and/or channel usage, when the traffic between the UE 804 and the first network entity 802a is lower compared to when the SCell is activated.

At 824, the UE 804 obtains, from the first network entity 802a via the second cell 810b, synchronization signaling (e.g., at least one synchronization signal) in accordance with the energy saving mode, for example, as described above with respect to 814.

FIG. 9 depicts another process flow 900 for SCell synchronization signaling mode switching in a system including a first network entity 902a, a second network entity 902b, and a UE 904. The first network entity 902a may communicate with the UE 904 via a first cell 910a (e.g., the first cell 510a of FIG. 5) and/or a second cell 910b (e.g., the second cell 510b of FIG. 5). In certain aspects, the first network entity 902a and/or second network entity 902b may be an example of the BS 102 depicted and described with respect to FIGS. 1 and 3 or a disaggregated base station depicted and described with respect to FIG. 2. In some aspects, the first network entity 902a may be an example of the DU 230 of FIG. 2, and the second network entity may be an example of the CU 210 of FIG. 2. Similarly, the UE 904 may be an example of UE 104 depicted and described with respect to FIGS. 1 and 3. However, in other aspects, UE 904 may be another type of wireless communications device, and network entities 902a, 902b may be another type of network entity or network node, such as those described herein. Note that any operations or signaling illustrated with dashed lines indicate that that operation or signaling may be an optional or alternative example.

At 906, the first network entity 902a communicates with the second network entity 902b to perform certain network entity SS configuration operations, for example, as described herein with respect to FIG. 8. The first network entity 902a may setup a configuration for synchronization signal communications in an active mode. For example, the first network entity 902a may send, to the second network entity 902b, a request for an active mode configuration for synchronization signaling.

At 908, the UE 904 obtains, from the first network entity 902a via the first cell 910a, a configuration for active mode synchronization signal communications. In certain aspects, the configuration may be or include a configuration for SCell communications via the second cell 910b. As an example, the configuration may add the second cell 910b as an SCell or modify an SCell configuration associated with the second cell 910b, for example, as discussed above with respect to FIG. 8. The configuration may indicate a set of parameters for synchronization signal communications in an active mode, for example, as described herein with respect to FIG. 6. The configuration may indicate the set of parameters for the active mode without another set of parameters for synchronization signal communications in an energy saving mode. Expressed another way, the configuration may provide only a single set of parameters for synchronization signal communications. In certain aspects, the configuration may be obtained via RRC signaling and/or system information.

At 910, the UE 904 obtains, from the first network entity 902a via the first cell 910a, an indication that the second cell 910b is activated for communications as an SCell between the UE 904 and the first network entity 902a.

At 912, the UE 904 obtains, from the first network entity 902a via the second cell 910b, synchronization signaling (e.g., at least one synchronization signal) in accordance with the active mode, for example, as described above with respect to FIG. 8.

At 914, the UE 904 communicates with the first network entity 902a via the second cell 910b based on the synchronization signaling obtained at 912. The synchronization signaling may indicate or carry timing, frequency, and/or spatial information for one or more communication links (e.g., via the second cell 910b) between the UE 904 and the first network entity 902a. For example, the synchronization signaling may be used to determine time and/or frequency synchronization parameters (e.g., pre-compensation parameters) for communications via the second cell 910b. The synchronization signaling may indicate quasi colocation (QCL) information, such as transmit and/or receive beamforming, associated with the second cell 910b.

At 916, the UE 904 obtains, from the first network entity 902a via the first cell 910a, an indication to deactivate the second cell 910b for communication as an SCell.

At 918, the first network entity 902a communicates with the second network entity 902b to perform certain network entity SS configuration operations, for example, as described herein with respect to FIG. 8. The first network entity 902a sets up a configuration for synchronization signal communications in the energy saving mode. The first network entity 902a may setup a configuration for synchronization signal communications in an energy saving mode. For example, the first network entity 902a may send, to the second network entity 902b, a request for an energy saving mode configuration for synchronization signaling.

At 920, the UE 904 obtains, from the first network entity 902a via the first cell 910a, a configuration for energy saving mode synchronization signal communications. In certain aspects, the configuration may be or include a configuration for SCell communications via the second cell 910b. As an example, the configuration may add the second cell 910b as an SCell or modify SCell configuration associated with the second cell 910b. The configuration may indicate a set of parameters for synchronization signal communications in an energy saving mode, for example, as described herein with respect to FIG. 6. The configuration may indicate the set of parameters for the energy saving mode without another set of parameters for synchronization signal communications in an energy saving mode. Expressed another way, the configuration may provide only a single set of parameters for synchronization signal communications. In certain aspects, the configuration may be obtained via RRC signaling and/or system information. Switching to the energy saving mode upon deactivation of the SCell may enable the first network entity 902a and/or UE 904 to reduce energy consumption and/or channel usage, when the traffic between the UE 904 and the first network entity 902a is lower compared to when the SCell is activated.

At 922, the UE 904 obtains, from the first network entity 902a via the second cell 910b, synchronization signaling (e.g., at least one synchronization signal) in accordance with the energy saving mode, for example, as described above with respect to FIG. 8.

### Examples of UE-Specific SCell Synchronization Signaling Modes

As an SCell may be a UE-specific configuration, multiple UEs may have an activated and/or deactivated SCell at different time periods, which may be overlapping or non-overlapping in time. Thus, in some cases, the energy saving modes and/or active mode for synchronization signaling of the UEs may be overlapping or non-overlapping in time. In certain aspects, the network entity may configure the synchronization signaling modes of multiple UEs to overlap in time, such as overlapping active modes and/or overlapping energy saving modes, in order to enable efficient channel usage and/or power consumption.

In certain aspects, the network entity may configure or schedule the multi-mode synchronization signaling to accommodate multiple UEs communicating with the SCell in active modes and/or energy saving modes. For example, the active mode for synchronization signaling communications may be configured to enable a UE monitoring for synchronization signaling in an energy saving mode to obtain the respective synchronization signaling. In some cases, the periodicity for an energy saving mode may be an integer multiple of the periodicity in the active mode with the same half frame offset in the energy saving mode and active mode. In certain cases, the component signals of the SSB in the energy saving mode (e.g. PSS and SSS only, PSS only, or SSS only) may have the same time-frequency locations as an SSB in the active mode. In some cases, the SSB burst pattern may be the same between the energy saving mode and the active mode. Thus, the synchronization signaling in the energy saving mode may overlap in time-frequency locations with the synchronization signaling in the active mode to accommodate multiple UEs. The overlapping configurations may allow a network entity to communicate synchronization signaling with multiple UEs having different synchronization signaling configurations.

FIG. 10 illustrates an example scheme 1000 of communicating multi-mode synchronization signaling with multiple UEs. In this example, each of a first UE (UE-1) and a second UE (UE-2) are configured with a configuration for multi-mode synchronization signaling having an energy saving mode and an active mode, for example, as described herein with respect to FIG. 6. The first UE may monitor for synchronization signaling in an energy saving mode during a first time period and then monitor for synchronization signaling in an active mode during a second time period, whereas the second UE may monitor for synchronization signaling in an energy saving mode during a third time period and then monitor for synchronization signaling in an active mode during a fourth time period. The first UE has an energy saving mode that overlaps in time with an active mode of the second UE. Likewise, a portion of the active mode of the first UE overlaps in time with the energy saving mode of the second UE. Accordingly, a network entity may communicate synchronization signaling in an energy saving mode for an overlapping energy saving mode time period 1010, and the network entity may communicate synchronization signaling in an active mode for an overlapping active mode time period 1012.

### Example Operations for Multi-Mode Synchronization Signaling

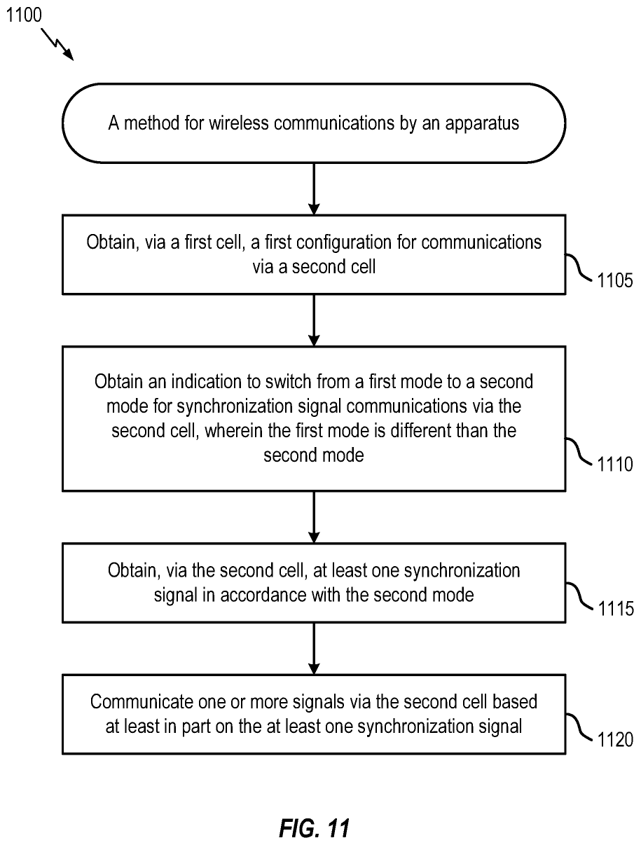

FIG. 11 shows a method 1100 for wireless communications by an apparatus, such as UE 104 of FIGS. 1 and 3.

Method 1100 begins at block 1105 with obtaining, via a first cell, a first configuration (e.g., an SCell configuration) for communications via a second cell. In certain aspects, the first cell is a primary cell in a cell group, and the second cell is a secondary cell in the cell group.

Method 1100 then proceeds to block 1110 with obtaining an indication to switch from a first mode (e.g., an energy saving mode) to a second mode (e.g., an active mode) for synchronization signal communications via the second cell, wherein the first mode is different than the second mode. As an example, the indication to switch from the first mode to the second mode may include an indication to active or deactivate an SCell for communications.

Method 1100 then proceeds to block 1115 with obtaining, via the second cell, at least one synchronization signal in accordance with the second mode. For example, a UE may obtain the at least one synchronization signal in one or more transmission occasions (e.g., time-frequency resource(s)) allocated for the second mode.

Method 1100 then proceeds to block 1120 with communicating one or more signals via the second cell based at least in part on the at least one synchronization signal. For example, the synchronization signal may carry and/or indicate timing, frequency, and/or QCL information for communications via the second cell.

In certain aspects, method 1100 further includes obtaining a second configuration that indicates one or more parameters for the synchronization signal communications via the second cell in one or more of: the first mode or the second mode. In certain aspects, the one or more parameters comprises one or more of: a periodicity for a set of one or more synchronization signals (e.g., the first SS set 606 of FIG. 6); an indication of one or more component signals (e.g., PSS, SSS, PBCH, and/or TSS) in the set of one or more synchronization signals; an indication of a burst pattern for the set of one or more synchronization signals; or an indication of a total number of SSBs in the set of one or more synchronization signals.

In certain aspects, when the one or more parameters comprise the periodicity, the periodicity for the set of one or more synchronization signals associated with the second mode is shorter than a respective periodicity associated with the first mode, when the one or more parameters comprise the indication of one or more component signals, a total number of the one or more component signals associated with the second mode is greater than a respective total number of the one or more component signals associated with the first mode, when the one or more parameters comprise the indication of the burst pattern, the burst pattern for the set of one or more synchronization signals associated with the second mode is shorter in duration than a respective burst pattern associated with the first mode, and when the one or more parameters comprise the indication of the total number of SSBs, the total number of SSBs in the set of one or more synchronization signals associated with the second mode is greater than a respective total number of SSBs associated with the first mode.

In certain aspects, the indication to switch from the first mode to the second mode comprises an indication to activate the first configuration for communications via the second cell.

In certain aspects, the indication to switch from the first mode to the second mode comprises an indication that the second mode is applied while an active BWP of the second cell is in an active state (e.g., a non-dormancy state).

In certain aspects, block 1110 includes obtaining signaling that indicates to switch from the first mode to the second mode. In certain aspects, the signaling comprises one or more of: an indication of a start time for the second mode, an indication of an end time for the second mode, an indication of a duration for the second mode, or an indication to use the second mode until a switch to a different mode. In certain aspects, the first configuration indicates one or more parameters for the first mode, and the signaling comprises a second configuration that indicates a modification to the one or more parameters of the first mode to be in the second mode. In certain aspects, the second configuration comprises a radio resource control configuration for the second cell.

In certain aspects, method 1100 further includes obtaining: a second configuration that indicates one or more first parameters for the synchronization signal communications via the second cell in the first mode, and a third configuration that indicates one or more second parameters for the synchronization signal communications via the second cell in the second mode; and block 1110 includes obtaining an indication to activate the third configuration and deactivate the second configuration. In certain aspects, the indication to activate the third configuration comprises an indication to activate the first configuration for communications via the second cell. In certain aspects, the indication to switch from the first mode to the second mode comprises an indication that the second mode is applied while an active BWP of the second cell is in an active state. In certain aspects, the indication to switch from the first mode to the second mode comprises an indication of a burst pattern for the second mode. In certain aspects, the third configuration comprises a radio resource control configuration, and the indication to switch from the first mode to the second mode comprises one or more of: a DCI message or a MAC-CE. In certain aspects, the indication to switch from the first mode to the second mode comprises one or more of: a DCI message or a MAC-CE.

In certain aspects, block 1115 includes obtaining, via the second cell, the at least one synchronization signal in a transmission occasion offset in time based at least in part on the indication to switch from the first mode to the second mode.

In certain aspects, the indication to switch from the first mode to the second mode comprises an indication of a selection of a subset of SSBs in a set of SSBs.

In certain aspects, method 1100 further includes obtaining an indication to switch from the second mode to the first mode for synchronization signal communications via the second cell.

In certain aspects, method 1100 further includes obtaining, via the second cell, one or more synchronization signals in accordance with the first mode.

In certain aspects, method 1100 further includes sending an indication of when the one or more synchronization signals are obtained with respect to a time reference associated with the first cell.

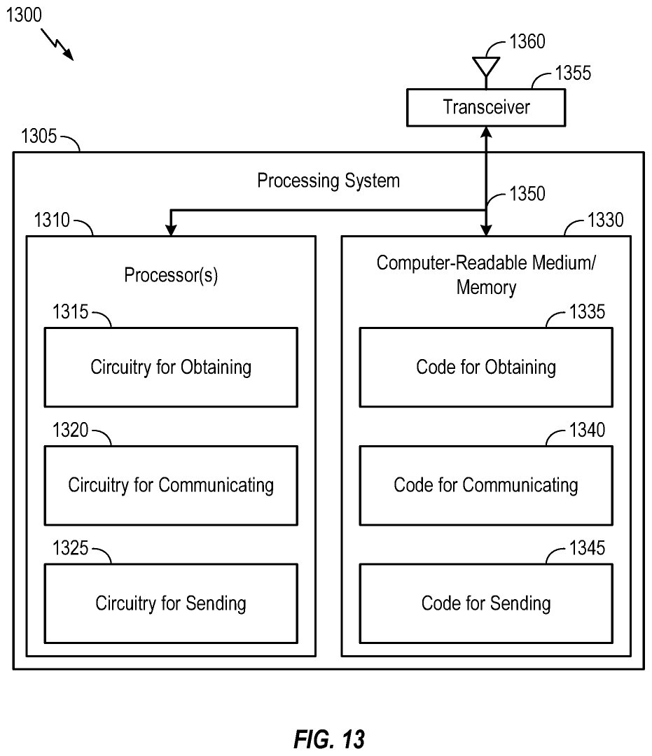

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

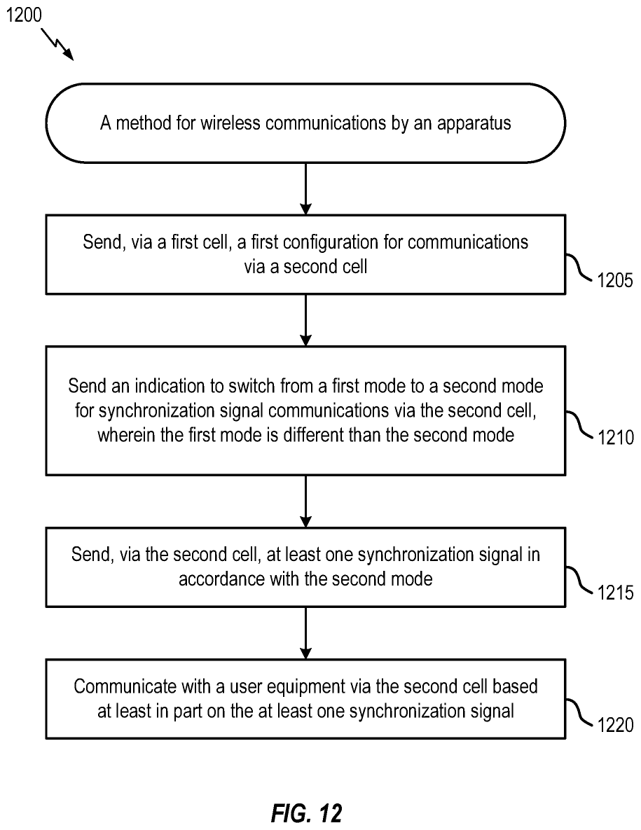

FIG. 12 shows a method 1200 for wireless communications by an apparatus, such as BS 102 of FIGS. 1 and 3, or a disaggregated base station as discussed with respect to FIG. 2.

Method 1200 begins at block 1205 with sending, via a first cell, a first configuration for communications via a second cell. In certain aspects, the first cell is a primary cell in a cell group, and the second cell is a secondary cell in the cell group.

Method 1200 then proceeds to block 1210 with sending an indication to switch from a first mode to a second mode for synchronization signal communications via the second cell, wherein the first mode is different than the second mode. As an example, the indication to switch from the first mode to the second mode may include an indication to active or deactivate an SCell for communications.

Method 1200 then proceeds to block 1215 with sending, via the second cell, at least one synchronization signal in accordance with the second mode. For example, a network entity may send the at least one synchronization signal in one or more transmission occasions (e.g., time-frequency resource(s)) allocated for the second mode.

Method 1200 then proceeds to block 1220 with communicating with a user equipment via the second cell based at least in part on the at least one synchronization signal. For example, the synchronization signal may carry and/or indicate timing, frequency, and/or QCL information for communications via the second cell.

In certain aspects, method 1200 further includes sending a second configuration that indicates one or more parameters for the synchronization signal communications via the second cell in one or more of: the first mode or the second mode. In certain aspects, the one or more parameters comprises one or more of: a periodicity for a set of one or more synchronization signals; an indication of one or more component signals in the set of one or more synchronization signals; an indication of a burst pattern for the set of one or more synchronization signals; or an indication of a total number of SSBs in the set of one or more synchronization signals.

In certain aspects, when the one or more parameters comprise the periodicity, the periodicity for the set of one or more synchronization signals associated with the second mode is shorter than a respective periodicity associated with the first mode, when the one or more parameters comprise the indication of one or more component signals, a total number of the one or more component signals associated with the second mode is greater than a respective total number of the one or more component signals associated with the first mode, when the one or more parameters comprise the indication of the burst pattern, the burst pattern for the set of one or more synchronization signals associated with the second mode is shorter in duration than a respective burst pattern associated with the first mode, and when the one or more parameters comprise the indication of the total number of SSBs, the total number of SSBs in the set of one or more synchronization signals associated with the second mode is greater than a respective total number of SSBs associated with the first mode.

In certain aspects, the indication to switch from the first mode to the second mode comprises an indication to activate the first configuration for communications via the second cell.

In certain aspects, the indication to switch from the first mode to the second mode comprises an indication that the second mode is applied while an active BWP of the second cell is in an active state (e.g., a non-dormancy state).

In certain aspects, block 1210 includes sending signaling that indicates to switch from the first mode to the second mode. In certain aspects, the signaling comprises one or more of: an indication of a start time for the second mode, an indication of an end time for the second mode, an indication of a duration for the second mode, or an indication to use the second mode until a switch to a different mode. In certain aspects, the first configuration indicates one or more parameters for the first mode, and the signaling comprises a second configuration that indicates a modification to the one or more parameters of the first mode to be in the second mode. In certain aspects, the second configuration comprises a radio resource control configuration for the second cell.

In certain aspects, method 1200 further includes sending: a second configuration that indicates one or more first parameters for the synchronization signal communications via the second cell in the first mode, and a third configuration that indicates one or more second parameters for the synchronization signal communications via the second cell in the second mode; and block 1210 includes sending an indication to activate the third configuration and deactivate the second configuration. In certain aspects, the indication to activate the third configuration comprises an indication to activate the first configuration for communications via the second cell. In certain aspects, the indication to switch from the first mode to the second mode comprises an indication that the second mode is applied while an active BWP of the second cell is in an active state. In certain aspects, the indication to switch from the first mode to the second mode comprises an indication of a burst pattern for the second mode. In certain aspects, the third configuration comprises a radio resource control configuration, and the indication to switch from the first mode to the second mode comprises one or more of: a DCI message or a MAC-CE. In certain aspects, the indication to switch from the first mode to the second mode comprises one or more of: a DCI message or a MAC-CE.

In certain aspects, block 1215 includes sending, via the second cell, the at least one synchronization signal in a transmission occasion offset in time based at least in part on the indication to switch from the first mode to the second mode.

In certain aspects, the indication to switch from the first mode to the second mode comprises an indication of a selection of a subset of SSBs in a set of SSBs.

In certain aspects, method 1200 further includes sending an indication to switch from the second mode to the first mode for synchronization signal communications via the second cell.

In certain aspects, method 1200 further includes sending, via the second cell, one or more synchronization signals in accordance with the first mode.

In certain aspects, method 1200 further includes obtaining an indication of when the one or more synchronization signals are obtained with respect to a time reference associated with the first cell.

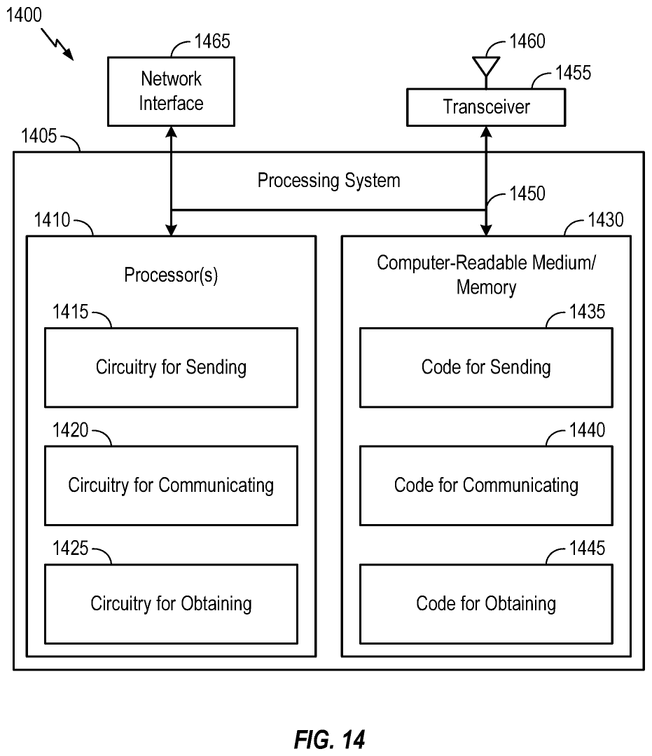

In certain aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300. In some aspects, communications device 1300 is a user equipment, such as UE 104 described above with respect to FIGS. 1 and 3.

The communications device 1300 includes a processing system 1305 coupled to a transceiver 1355 (e.g., a transmitter and/or a receiver). The transceiver 1355 is configured to transmit and receive signals for the communications device 1300 via an antenna 1360, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code) that when executed by the one or more processors 1310, enable and cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1330 stores code for obtaining 1335, code for communicating 1340, and code for sending 1345. Processing of the code 1335-1345 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1330, including circuitry for obtaining 1315, circuitry for communicating 1320, and circuitry for sending 1325. Processing with circuitry 1315-1325 may enable and cause the communications device 1300 to perform the method 1100 described with respect to FIG. 11, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1355 and/or antenna 1360 of the communications device 1300 in FIG. 13, and/or one or more processors 1310 of the communications device 1300 in FIG. 13. Means for communicating, receiving or obtaining may include the transceivers 354, antenna(s) 352, receive processor 358, AI processor 370, and/or controller/processor 380 of the UE 104 illustrated in FIG. 3, transceiver 1355 and/or antenna 1360 of the communications device 1300 in FIG. 13, and/or one or more processors 1310 of the communications device 1300 in FIG. 13.

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to a transceiver 1455 (e.g., a transmitter and/or a receiver) and/or a network interface 1465. The transceiver 1455 is configured to transmit and receive signals for the communications device 1400 via an antenna 1460, such as the various signals as described herein. The network interface 1465 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code) that when executed by the one or more processors 1410, enable and cause the one or more processors 1410 to perform the method 1200 described with respect to FIG. 12, or any aspect related to it, including any operations described in relation to FIG. 12. Note that reference to a processor of communications device 1400 performing a function may include one or more processors of communications device 1400 performing that function, such as in a distributed fashion.

In the depicted example, the computer-readable medium/memory 1430 stores code for sending 1435, code for communicating 1440, and code for obtaining 1445. Processing of the code 1435-1445 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1430, including circuitry for sending 1415, circuitry for communicating 1420, and circuitry for obtaining 1425. Processing with circuitry 1415-1425 may enable and cause the communications device 1400 to perform the method 1200 described with respect to FIG. 12, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1455, antenna 1460, and/or network interface 1465 of the communications device 1400 in FIG. 14, and/or one or more processors 1410 of the communications device 1400 in FIG. 14. Means for communicating, receiving or obtaining may include the transceivers 332, antenna(s) 334, receive processor 338, AI processor 318, and/or controller/processor 340 of the BS 102 illustrated in FIG. 3, transceiver 1455, antenna 1460, and/or network interface 1465 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by an apparatus comprising: obtaining, via a first cell, a first configuration for communications via a second cell; obtaining an indication to switch from a first mode to a second mode for synchronization signal communications via the second cell, wherein the first mode is different than the second mode; obtaining, via the second cell, at least one synchronization signal in accordance with the second mode; and communicating one or more signals via the second cell based at least in part on the at least one synchronization signal.

Clause 2: The method of Clause 1, wherein the first cell is a primary cell in a cell group, and the second cell is a secondary cell in the cell group.

Clause 3: The method of any one of Clauses 1-2, further comprising obtaining a second configuration that indicates one or more parameters for the synchronization signal communications via the second cell in one or more of: the first mode or the second mode.

Clause 4: The method of Clause 3, wherein the one or more parameters comprises one or more of: a periodicity for a set of one or more synchronization signals; an indication of one or more component signals in the set of one or more synchronization signals; an indication of a burst pattern for the set of one or more synchronization signals; or an indication of a total number of SSBs in the set of one or more synchronization signals.

Clause 5: The method of Clause 4, wherein: when the one or more parameters comprise the periodicity, the periodicity for the set of one or more synchronization signals associated with the second mode is shorter than a respective periodicity associated with the first mode, when the one or more parameters comprise the indication of one or more component signals, a total number of the one or more component signals associated with the second mode is greater than a respective total number of the one or more component signals associated with the first mode, when the one or more parameters comprise the indication of the burst pattern, the burst pattern for the set of one or more synchronization signals associated with the second mode is shorter in duration than a respective burst pattern associated with the first mode, and when the one or more parameters comprise the indication of the total number of SSBs, the total number of SSBs in the set of one or more synchronization signals associated with the second mode is greater than a respective total number of SSBs associated with the first mode.

Clause 6: The method of any one of Clauses 1-5, wherein the indication to switch from the first mode to the second mode comprises an indication to activate the first configuration for communications via the second cell.

Clause 7: The method of Clause 6, wherein the indication to switch from the first mode to the second mode comprises an indication that the second mode is applied while an active BWP of the second cell is in an active state.

Clause 8: The method of any one of Clauses 1-7, wherein obtaining the indication to switch from the first mode to the second mode comprises obtaining signaling that indicates to switch from the first mode to the second mode.

Clause 9: The method of Clause 8, wherein the signaling comprises one or more of: an indication of a start time for the second mode, an indication of an end time for the second mode, an indication of a duration for the second mode, or an indication to use the second mode until a switch to a different mode.

Clause 10: The method of Clause 8 or 9, wherein: the first configuration indicates one or more parameters for the first mode, and the signaling comprises a second configuration that indicates a modification to the one or more parameters of the first mode to be in the second mode.

Clause 11: The method of Clause 10, wherein the second configuration comprises a radio resource control configuration for the second cell.

Clause 12: The method of any one of Clauses 1-11, further comprising obtaining: a second configuration that indicates one or more first parameters for the synchronization signal communications via the second cell in the first mode, and a third configuration that indicates one or more second parameters for the synchronization signal communications via the second cell in the second mode; wherein obtaining the indication to switch from the first mode to the second mode comprises obtaining an indication to activate the third configuration and deactivate the second configuration.

Clause 13: The method of Clause 12, wherein the indication to activate the third configuration comprises an indication to activate the first configuration for communications via the second cell.

Clause 14: The method of Clause 13, wherein the indication to switch from the first mode to the second mode comprises an indication that the second mode is applied while an active BWP of the second cell is in an active state.

Clause 15: The method of any one of Clause 12-14, wherein the indication to switch from the first mode to the second mode comprises an indication of a burst pattern for the second mode.

Clause 16: The method of Clause 15, wherein: the third configuration comprises a radio resource control configuration, and the indication to switch from the first mode to the second mode comprises one or more of: a DCI message or a MAC-CE.

Clause 17: The method of any one of Clauses 12-16, wherein the indication to switch from the first mode to the second mode comprises one or more of: a DCI message or a MAC-CE.

Clause 18: The method of any one of Clauses 1-17, wherein obtaining the at least one synchronization signal comprises obtaining, via the second cell, the at least one synchronization signal in a transmission occasion offset in time based at least in part on the indication to switch from the first mode to the second mode.

Clause 19: The method of any one of Clauses 1-18, wherein the indication to switch from the first mode to the second mode comprises an indication of a selection of a subset of SSBs in a set of SSBs.

Clause 20: The method of any one of Clauses 1-19, further comprising: obtaining an indication to switch from the second mode to the first mode for synchronization signal communications via the second cell; obtaining, via the second cell, one or more synchronization signals in accordance with the first mode; and sending an indication of when the one or more synchronization signals are obtained with respect to a time reference associated with the first cell.

Clause 21: A method for wireless communications by an apparatus comprising: sending, via a first cell, a first configuration for communications via a second cell; sending an indication to switch from a first mode to a second mode for synchronization signal communications via the second cell, wherein the first mode is different than the second mode; sending, via the second cell, at least one synchronization signal in accordance with the second mode; and communicating with a user equipment via the second cell based at least in part on the at least one synchronization signal.

Clause 22: The method of Clause 21, wherein the first cell is a primary cell in a cell group, and the second cell is a secondary cell in the cell group.

Clause 23: The method of any one of Clauses 21-22, further comprising sending a second configuration that indicates one or more parameters for the synchronization signal communications via the second cell in one or more of: the first mode or the second mode.

Clause 24: The method of Clause 23, wherein the one or more parameters comprises one or more of: a periodicity for a set of one or more synchronization signals; an indication of one or more component signals in the set of one or more synchronization signals; an indication of a burst pattern for the set of one or more synchronization signals; or an indication of a total number of SSBs in the set of one or more synchronization signals.

Clause 25: The method of Clause 24, wherein: when the one or more parameters comprise the periodicity, the periodicity for the set of one or more synchronization signals associated with the second mode is shorter than a respective periodicity associated with the first mode, when the one or more parameters comprise the indication of one or more component signals, a total number of the one or more component signals associated with the second mode is greater than a respective total number of the one or more component signals associated with the first mode, when the one or more parameters comprise the indication of the burst pattern, the burst pattern for the set of one or more synchronization signals associated with the second mode is shorter in duration than a respective burst pattern associated with the first mode, and when the one or more parameters comprise the indication of the total number of SSBs, the total number of SSBs in the set of one or more synchronization signals associated with the second mode is greater than a respective total number of SSBs associated with the first mode.

Clause 26: The method of any one of Clauses 21-25, wherein the indication to switch from the first mode to the second mode comprises an indication to activate the first configuration for communications via the second cell.

Clause 27: The method of Clause 26, wherein the indication to switch from the first mode to the second mode comprises an indication that the second mode is applied while an active BWP of the second cell is in an active state.

Clause 28: The method of any one of Clauses 21-27, wherein sending the indication to switch from the first mode to the second mode comprises sending signaling that indicates to switch from the first mode to the second mode.

Clause 29: The method of Clause 28, wherein the signaling comprises one or more of: an indication of a start time for the second mode, an indication of an end time for the second mode, an indication of a duration for the second mode, or an indication to use the second mode until a switch to a different mode.

Clause 30: The method of Clause 28 or 29, wherein: the first configuration indicates one or more parameters for the first mode, and the signaling comprises a second configuration that indicates a modification to the one or more parameters of the first mode to be in the second mode.

Clause 31: The method of Clause 30, wherein the second configuration comprises a radio resource control configuration for the second cell.

Clause 32: The method of any one of Clauses 21-31, further comprising sending: a second configuration that indicates one or more first parameters for the synchronization signal communications via the second cell in the first mode, and a third configuration that indicates one or more second parameters for the synchronization signal communications via the second cell in the second mode; wherein sending the indication to switch from the first mode to the second mode comprises sending an indication to activate the third configuration and deactivate the second configuration.

Clause 33: The method of Clause 32, wherein the indication to activate the third configuration comprises an indication to activate the first configuration for communications via the second cell.

Clause 34: The method of Clause 33, wherein the indication to switch from the first mode to the second mode comprises an indication that the second mode is applied while an active BWP of the second cell is in an active state.

Clause 35: The method of any one of Clauses 32-34, wherein the indication to switch from the first mode to the second mode comprises an indication of a burst pattern for the second mode.

Clause 36: The method of Clause 35, wherein: the third configuration comprises a radio resource control configuration, and the indication to switch from the first mode to the second mode comprises one or more of: a DCI message or a MAC-CE.

Clause 37: The method of any one of Clauses 32-36, wherein the indication to switch from the first mode to the second mode comprises one or more of: a DCI message or a MAC-CE.

Clause 38: The method of any one of Clauses 21-37, wherein sending the at least one synchronization signal comprises sending, via the second cell, the at least one synchronization signal in a transmission occasion offset in time based at least in part on the indication to switch from the first mode to the second mode.

Clause 39: The method of any one of Clauses 21-38, wherein the indication to switch from the first mode to the second mode comprises an indication of a selection of a subset of SSBs in a set of SSBs.

Clause 40: The method of any one of Clauses 21-39, further comprising: sending an indication to switch from the second mode to the first mode for synchronization signal communications via the second cell; sending, via the second cell, one or more synchronization signals in accordance with the first mode; and obtaining an indication of when the one or more synchronization signals are obtained with respect to a time reference associated with the first cell.

Clause 41: One or more apparatuses, comprising: one or more memories comprising executable instructions; and one or more processors configured to execute the executable instructions and cause the one or more apparatuses to perform a method in accordance with any one of Clauses 1-40.

Clause 42: One or more apparatuses, comprising: one or more memories; and one or more processors, coupled to the one or more memories, configured to cause the one or more apparatuses to perform a method in accordance with any one of Clauses 1-40.

Clause 43: One or more apparatuses, comprising: one or more memories; and one or more processors, coupled to the one or more memories, configured to perform a method in accordance with any one of Clauses 1-40.

Clause 44: One or more apparatuses, comprising means for performing a method in accordance with any one of Clauses 1-40.

Clause 45: One or more non-transitory computer-readable media comprising executable instructions that, when executed by one or more processors of one or more apparatuses, cause the one or more apparatuses to perform a method in accordance with any one of Clauses 1-40.

Clause 46: One or more computer program products embodied on one or more computer-readable storage media comprising code for performing a method in accordance with any one of Clauses 1-40.

Clause 47: A user equipment (UE), comprising: a processing system that includes processor circuitry and memory circuitry that stores code and is coupled with the processor circuitry, the processing system configured to cause the UE to perform a method in accordance with any one of Clauses 1-20.

Clause 48: A network entity, comprising: a processing system that includes processor circuitry and memory circuitry that stores code and is coupled with the processor circuitry, the processing system configured to cause the network entity to perform a method in accordance with any one of Clauses 21-40.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain, via a first cell, a first configuration for communications via a second cell;
obtain an indication to switch from a first mode to a second mode for synchronization signal communications via the second cell, wherein the first mode is different than the second mode;
obtain, via the second cell, at least one synchronization signal in accordance with the second mode; and
communicate one or more signals via the second cell based at least in part on the at least one synchronization signal.

2. The apparatus of claim 1, wherein the first cell is a primary cell in a cell group, and the second cell is a secondary cell in the cell group.

3. The apparatus of claim 1, wherein the one or more processors are configured to cause the apparatus to obtain a second configuration that indicates one or more parameters for the synchronization signal communications via the second cell in one or more of: the first mode or the second mode.

4. The apparatus of claim 1, wherein the indication to switch from the first mode to the second mode comprises an indication to activate the first configuration for communications via the second cell.

5. The apparatus of claim 1, wherein to obtain the indication to switch from the first mode to the second mode, the one or more processors are configured to cause the apparatus to obtain signaling that indicates to switch from the first mode to the second mode.

6. The apparatus of claim 1, wherein:
the one or more processors are configured to cause the apparatus to obtain:
a second configuration that indicates one or more first parameters for the synchronization signal communications via the second cell in the first mode, and
a third configuration that indicates one or more second parameters for the synchronization signal communications via the second cell in the second mode; and
to obtain the indication to switch from the first mode to the second mode, the one or more processors are configured to cause the apparatus to obtain an indication to activate the third configuration and deactivate the second configuration.

7. The apparatus of claim 1, wherein to obtain the at least one synchronization signal, the one or more processors are configured to cause the apparatus to obtain, via the second cell, the at least one synchronization signal in a transmission occasion offset in time based at least in part on the indication to switch from the first mode to the second mode.

8. The apparatus of claim 1, wherein the indication to switch from the first mode to the second mode comprises an indication of a selection of a subset of synchronization signal blocks (SSBs) in a set of SSBs.

9. The apparatus of claim 1, wherein the one or more processors are configured to cause the apparatus to:
obtain an indication to switch from the second mode to the first mode for synchronization signal communications via the second cell;
obtain, via the second cell, one or more synchronization signals in accordance with the first mode; and
send an indication of when the one or more synchronization signals are obtained with respect to a time reference associated with the first cell.

10. An apparatus configured for wireless communications, comprising:
one or more memories; and
one or more processors coupled to the one or more memories, the one or more processors being configured to cause the apparatus to:
send, via a first cell, a first configuration for communications via a second cell;
send an indication to switch from a first mode to a second mode for synchronization signal communications via the second cell, wherein the first mode is different than the second mode;
send, via the second cell, at least one synchronization signal in accordance with the second mode; and
communicate with a user equipment via the second cell based at least in part on the at least one synchronization signal.

11. The apparatus of claim 10, wherein the first cell is a primary cell in a cell group, and the second cell is a secondary cell in the cell group.

12. The apparatus of claim 10, wherein the one or more processors are configured to cause the apparatus to send a second configuration that indicates one or more parameters for the synchronization signal communications via the second cell in one or more of: the first mode or the second mode.

13. The apparatus of claim 10, wherein the indication to switch from the first mode to the second mode comprises an indication to activate the first configuration for communications via the second cell.

14. The apparatus of claim 10, wherein to send the indication to switch from the first mode to the second mode, the one or more processors are configured to cause the apparatus to send signaling that indicates to switch from the first mode to the second mode.

15. The apparatus of claim 10, wherein:
the one or more processors are configured to cause the apparatus to send:
a second configuration that indicates one or more first parameters for the synchronization signal communications via the second cell in the first mode, and
a third configuration that indicates one or more second parameters for the synchronization signal communications via the second cell in the second mode; and
to send the indication to switch from the first mode to the second mode, the one or more processors are configured to cause the apparatus to send an indication to activate the third configuration and deactivate the second configuration.

16. The apparatus of claim 10, wherein to send the at least one synchronization signal, the one or more processors are configured to cause the apparatus to send, via the second cell, the at least one synchronization signal in a transmission occasion offset in time based at least in part on the indication to switch from the first mode to the second mode.

17. The apparatus of claim 10, wherein the indication to switch from the first mode to the second mode comprises an indication of a selection of a subset of synchronization signal blocks (SSBs) in a set of SSBs.

18. The apparatus of claim 10, wherein the one or more processors are configured to cause the apparatus to:
send an indication to switch from the second mode to the first mode for synchronization signal communications via the second cell;
send, via the second cell, one or more synchronization signals in accordance with the first mode; and
obtain an indication of when the one or more synchronization signals are obtained with respect to a time reference associated with the first cell.

19. A method of wireless communications by an apparatus, comprising:
obtaining, via a first cell, a first configuration for communications via a second cell;
obtaining an indication to switch from a first mode to a second mode for synchronization signal communications via the second cell, wherein the first mode is different than the second mode;
obtaining, via the second cell, at least one synchronization signal in accordance with the second mode; and
communicating one or more signals via the second cell based at least in part on the at least one synchronization signal.
